(19) United States
(12) Patent Application Publication
(10) Pub. No.: US 2001/0003869 A1
(43) Pub. Date: Jun. 21, 2001

(54) FOUR SIDED DUAL BLADE SHAVER

(76) Inventor: MANUAL ANTONIO ROCHA, FUNCHAL (PT)

Correspondence Address: MICHAEL I KROLL, 171 STILLWELL LANE, SYOSSET, NY, 11791

(21) Appl. No.: 09/221,444

(22) Filed: Dec. 28, 1998

(51) Int. Cl. B26B 21/22

(52) U.S. Cl. 30/41; 30/41.5; 30/346.57

(57) ABSTRACT

The present invention 10 discloses a safety razor 10 having dual blades 34 with multiple shaving surfaces having different blade lengths and/or blade shapes to provide a selection of shaving surfaces for the various types of hair encountered the body of the user. The present invention 10 includes longer blades 34 being both straight 36 and convex 38. The present invention 10 includes blades on the edges 40 of its head 20 which are both straight 36 and convex 38 and smaller in length for trimming close areas of the body. The handle 18 of the razor 10 has a conduit 17 located therein and traveling throughout the length of the handle 18 connecting to the blade cavity 48 whereby water 16 can travel through the handle 18 to the shaving heads 20 and in and around the shaving heads so that it will dislodge shaving debris from around the blades 34. Furthermore, the present invention 10 is equipped with a slidable plunger 26 which travels in the handle 18 cavity so that oils, creams or liquids can be applied through the razor by pressing on the plunger 26 as one shaves. Embodiments are disclosed for razors with a removable head 20, a single piece disposable razor 46, and a razor with only two straight blades 54.

### BACKGROUND OF THE INVENTION

1. Field of the Invention

The present invention relates generally to safety razors and, more specifically, to a safety razor with a detachable and replaceable shaving head having dual blades which project from four sides providing four varied blade types for selectively shaving different body areas and said safety razor having an elongated handle wherein said handle has a channel located down the center of the handle with an opening at the base of said handle and an opening into the blade cavity whereby water will travel from the opening in the end of the handle to the shaving head where it will dislodge shaving debris from around the blades.

Another embodiment provides for a disposable safety razor having a fixed head as the preferred embodiment and having all other characteristics as the preferred embodiment.

An additional embodiment is provided having dual blades with one straight edge shaving surface and an oppositely opposed convex edge shaving surface and having an elongated handle wherein said handle has a channel located down the center of the handle with an opening at the base of said handle and an opening into the blade cavity whereby water will travel from the opening in the end of the handle to the shaving head where it will dislodge shaving debris from around the blades.

2. Description of the Prior Art

There are other safety razors designed with angular blades with more than one shaving surface. Typical of these is U.S. Pat. No. 4,534,110 issued to Glass on Aug. 13, 1985.

Another patent was issued to Mondo et al. on Feb. 22, 1994 as U.S. Pat. No. 5,287,624. Yet another U.S. Pat. No. 5,343,622 was issued to Andrews on Sep. 6, 1994 and still yet another was issued on Jul. 23, 1996 to Cacioppo as U.S. Pat. No. 5,537,749.

### U.S. Pat. No. 4,534,110

### Inventor: Henry P. Glass

### Issued: Aug. 13, 1985

A triple-edge safety razor in which no portion thereof are disconnected during use. The razor employs a novel blade assembly wherein three individual strip blades are interconnected by a flexible central web affording hinged connection therebetween. A number of methods of manufacture of the blade assembly are described.

### U.S. Pat. No. 5,287,624

### Inventor: Luciano G. Mondo et al.

### Issued: Feb. 22, 1994

An improved disposable safety razor is provided which consists of an elongated handle with a head having a convex top surface and a flat bottom surface attached to an upper end of the elongated handle. A pair of single cutting edge razor blades are clamped parallel within the head with the cutting edges angled outwardly and upwardly in opposite directions from the convex top surface of the head, so as to be useful in shaving in both forward and rearward strokes.

### U.S. Pat. No. 5,343,622

### Inventor: Edward A. Andrews

### Issued: Sep. 6, 1994

A bi-directional razor device is formed of a narrow, elongated head and a transversely extending, internal hand grip formed of molded plastic material. Two pair of narrow, strip like razor blades are embedded in the head, with one pair extending in one direction and the other pair extending in an opposite direction at an acute angle relative to the first pair. The blades extend along the length of the head. Thus, the user may move the razor head in one direction for contacting one pair of blades against the users skin for cutting hair and then move the handle in the opposite direction while the blades remain engaged upon the skin for cutting hair in both directions.

### U.S. Pat. No. 5,537,749

### Inventor: Tony Cacioppo

### Issued: Jul. 23, 1996

A razor including a shaving head with at least one blade attached to the shaving head which has an exposed shaving edge extending longitudinally on the having head for use in shaving. A passage is provided in the shaving head which extends from one end of the shaving head to the opposite end. Water for cleaning of the blades can be applied to an inlet under a running water faucet. A first outlet for discharging water from the passage is provided and is located adjacent to the shaving edge of the blade to clear shaving debris from the blade. The passage also includes a second outlet at the opposite end of the shaving head from the inlet. The second outlet has dimensions less than the dimensions of the inlet so that the volume of water passing through the inlet is greater than the volume of water passing through the second outlet. The difference in size between the inlet of the passage and the second outlet causes the fluidic pressure of the rinsing water to increase as the water travels from the inlet towards the second outlet. The increasing pressure of the rinsing water causes the water to flow through the first outlet with greater force, while still allowing a portion of the rinsing water to flow out of the second outlet.

While these safety razors may be suitable for the purposes for which they were designed, they would not be as suitable for the purposes of the present invention, as hereinafter described.

### SUMMARY OF THE PRESENT INVENTION

The present invention discloses a safety razor having dual blades with multiple shaving surfaces having different blade lengths and/or blade shapes to provide a selection of shaving surfaces for the various types of hair encountered on one's body. The present invention includes longer blades being both straight and convex. The present invention includes blades on the edges of its head which are both straight and convex and smaller in length for trimming close areas of the body. The handle of the razor has a conduit located therein and traveling throughout the length of the handle connecting to the blade cavity whereby water can travel through the handle to the shaving heads and in and around the shaving heads so that it will dislodge shaving debris from around the blades. Furthermore, the present invention is equipped with a slidable plunger which travels in the handle cavity so that oils, creams or liquids can be applied through the razor by pressing on the plunger as one shaves. Embodiments are disclosed for razors with a removable head, a single piece disposable razor, and a razor with only two straight blades.

A primary object of the present invention is to provide a safety razor with dual blades having multiple shaving surfaces.

Another object of the present invention is to provide a safety razor having different blade lengths and/or blade edges to provide a selection of shaving blades for different types of hair removal.

Yet another object of the present invention is to provide a safety razor having an elongated handle wherein a channel is located within the center of the handle having an opening at one distal end and another opening leading into the blade cavity whereby water can travel from the opening in the end of the handle to the shaving head where it will dislodge shaving debris from around the blades.

Still yet another object of the present invention is to provide a safety razor having a plunger which can be inserted within the handle cavity whereby a number of oils, creams and liquids can be stored and selectively ejected during shaving.

Another object of the present invention is to provide a safety razor with a removable disposable and replacable shaving head.

Yet another object of the present invention is to provide an additional embodiment of the present invention whereby the shaving head is not removable thereby providing a disposable safety razor.

Still yet another object of the present invention is to provide another additional embodiment of the present invention whereby the shaving head is not removable and the dual blades have two shaving surfaces wherein one edge is a straight edge and the oppositely opposed edge is convex.

Additional objects of the present invention will appear as the description proceeds.

The present invention overcomes the shortcomings of the prior art by providing a safety razor having dual blades with multiple shaving surfaces having different blade lengths and/or blade edges to provide a selection of shaving blades for varying types of hair removal and an elongated handle having a channel located within the center of the handle with an opening at one distal end and another opening leading into the blade cavity whereby water can travel from the opening in the end of the handle to the shaving head where it will dislodge shaving debris from around the blades and furthermore using a slideable plunger within the handle cavity a number of oils, creams and liquids can be applied while shaving.

The foregoing and other objects and advantages will appear from the description to follow. In the description reference is made to the accompanying drawings, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWINGS

In order that the invention may be more fully understood, it will now be described, by way of example, with reference to the accompanying drawing in which:

FIG. 1 is a perspective view of the preferred embodiment of the present invention being cleaned by placing the safety razor with the opening of the channel located at the base of the handle under running tap water therethrough the water will travel to the head of the razor and force the shaving debris from all cutting surfaces.

FIG. 2 is an enlarged view of the safety razor showing by arrows the path of the water as it travels from the channel opening located on the end of the handle through the head of the safety razor and around all blade surfaces.

FIG. 3 is a cross sectional view of the preferred embodiment of the present invention, taken from FIG. 2 as indicated, showing the channel within the handle and the means for connecting the handle to the disposable and replaceable shaving head.

FIG. 4 is an exploded view of the major components of the preferred embodiment of the present invention. Shown is a plunger which can be used to inject fluids and creams through the head of the razor. Also shown is the handle having means for securing the handle to the shaving head. Also shown, is the shaving head.

FIG. 5 is an exploded view of the components of the shaving head of the preferred embodiment. Shown are upper and lower housing members with a mating central blade spacer. Also shown are two blades having a straight edge on one long side and a convex blade edge on the oppositely opposed side and a significantly smaller straight edge on one short sides and a convex short blade located on the other short side.

FIG. 6 is a sectional view of the hollow handle wherein by use of the plunger an amount of liquid or cream can be stored and selectively dispensed while shaving.

FIG. 7 is a perspective view of an additional disposable embodiment of the present invention.

FIG. 8 is a cross sectional view of the additional embodiment of the present invention, taken from FIG. 7 as indicated, showing the one piece handle and the lower blade retaining member and the channel within the handle for cleaning purposes and for carrying oils, creams, and liquids to be dispensed through the blade cavity.

FIG. 9 is a perspective view of another additional embodiment of the present invention having dual blades with one shaving surface with a channel located down the center of the handle and opening into the blade cavity whereby water will travel from the opening in the end of the handle to the shaving head where it will dislodge shaving debris from around the blades of the safety razor. In addition oils, creams, and liquids can be carried within the handle cavity and dispensed while shaving.

FIG. 10 is a top view of the additional embodiment, taken from FIG. 9 as indicated, showing the single dual bladed shaving surface.

FIG. 11 is a cross sectional view of the additional embodiment of the present invention, taken from FIG. 9 as indicated, showing the dual blades with one shaving surface with a channel located down the center of the handle and opening into the blade cavity whereby water will travel from the opening in the end of the handle to the shaving head where it will dislodge shaving debris from around the blade surfaces.

### LIST OF REFERENCE NUMERALS

10 present invention

12 user

14 water faucet

16 water stream

17 conduit

18 handle

19 opening of conduit

20 head

22 arrows depicting water flow

24 handle connecting means

25 handle slot

26 plunger

28 upper head portion

30 lower head portion

32 space

34 blades

36 straight edge

38 convex edge

40 straight end edge

42 convex end edge

44 plunger end

45 plunger seal

46 lower blade retaining member

48 blade cavity

50 blades

54 dual blade

### DESCRIPTION OF THE PREFERRED EMBODIMENTS

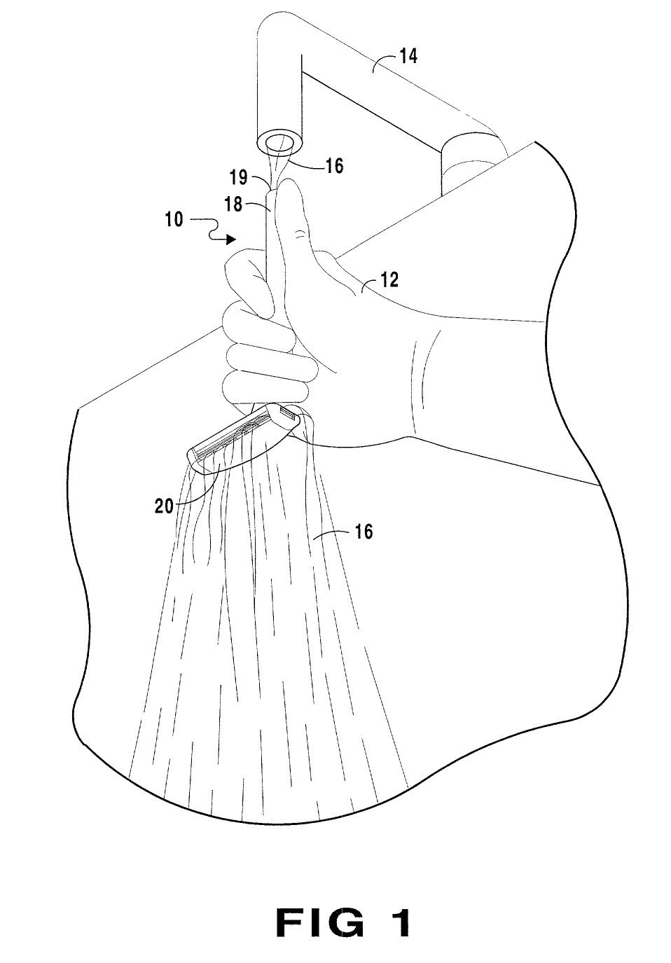

Turning now descriptively to the drawings, in which similar reference characters denote similar elements throughout the several views, FIGS. 1 through 11 illustrate the present invention being a razor with multiple style blades. With regard to the reference numerals used, the following numbering is used throughout the various figures.

Turning to FIG. 1, therein is shown a perspective view of the preferred embodiment of the present invention 10 in the hand of a user 12 being cleaned by placing the safety razor 10 with the opening 19 of the conduit of the handle 18 located at the base of the handle 18 under running tap water 16 furnished by a water faucet 14. As can be seen, the tap water 16 runs through the handle 18 and travels to the head of the razor 20 thereby forcing shaving debris from all cutting surfaces.

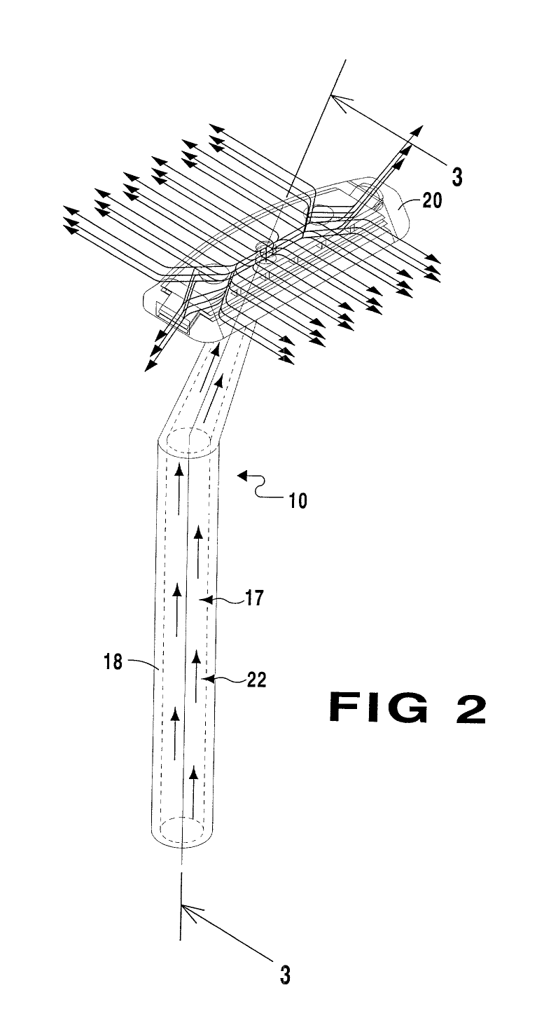

Turning to FIG. 2, therein is shown an enlarged view of the safety razor 10 showing with arrows 22 the path the water travels through the conduit 17 located in the handle 18 through the head 20 of the safety razor and around all the blade surfaces thereby cleaning the razor 10.

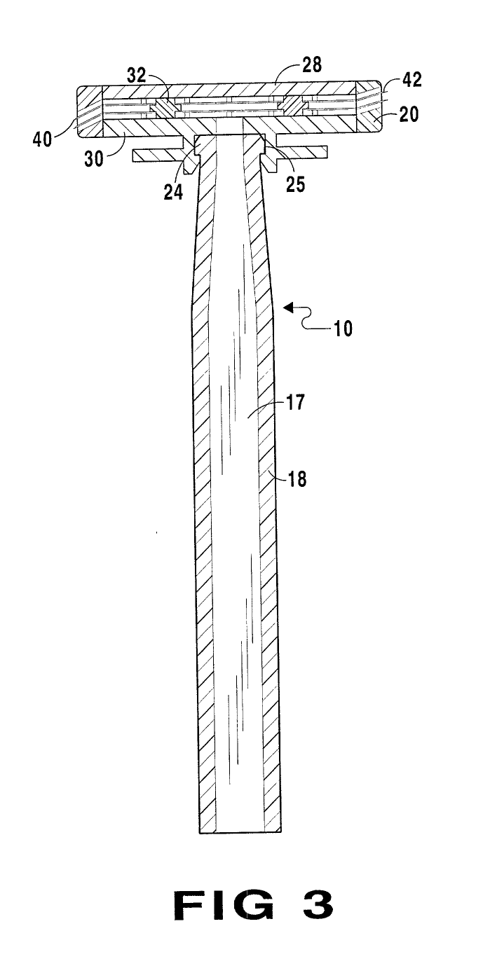

Turning to FIG. 3, therein is shown a cross sectional view of the preferred embodiment of the present invention 10 taken from FIG. 2 as indicated, showing the conduit 17 within the handle 18 and the means 24 for connecting the handle 18 to the disposable and replaceable shaving head 20. As can be seen the means for connecting the handle 24 to the shaving head 20 comprises an enlarged means on the end of the handle 18 which fits into a slot or groove 25 located on the underside of the shaving head 20 somewhat similar to a tongue in groove connection. Shown are upper 28 and lower 30 housing members with a mating central blade spacer 32. Also shown are significantly smaller straight edge blades 40 on one end and a convex short blade 42 on the opposing end.

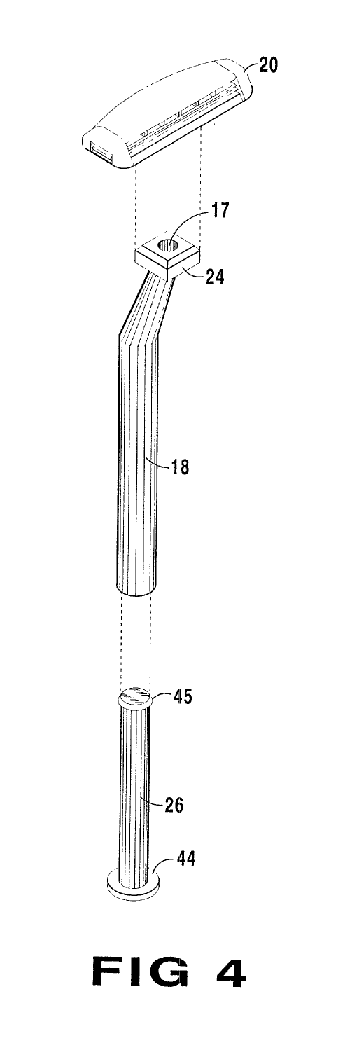

Turning to FIG. 4, therein is shown an exploded view of the major components of the preferred embodiment of the present invention 10. Shown is a plunger 26 which can be used to inject fluids and creams placed into the conduit 17 through the head 20 of the razor 10. The plunger 26 has an enlarged head on which to push it into the handle 18 which also serves as a stop to prevent the plunger 26 from being pushed too far into the handle 18. A smaller enlarged end 45 acts as a seal to hold the plunger 26 tightly in contact with the handle 18 interior. Also shown is the handle 18 having means for securing the handle 24 to the shaving head 20. As can be seen the means 24 for connecting the handle 18 to the shaving head 20 comprises an enlarged end on the end of the handle 18 which fits into a slot or groove 25 located on the underside of the shaving head 20 somewhat similar to a tongue in groove connection. Also shown is the opening from the conduit 17 in the handle 18.

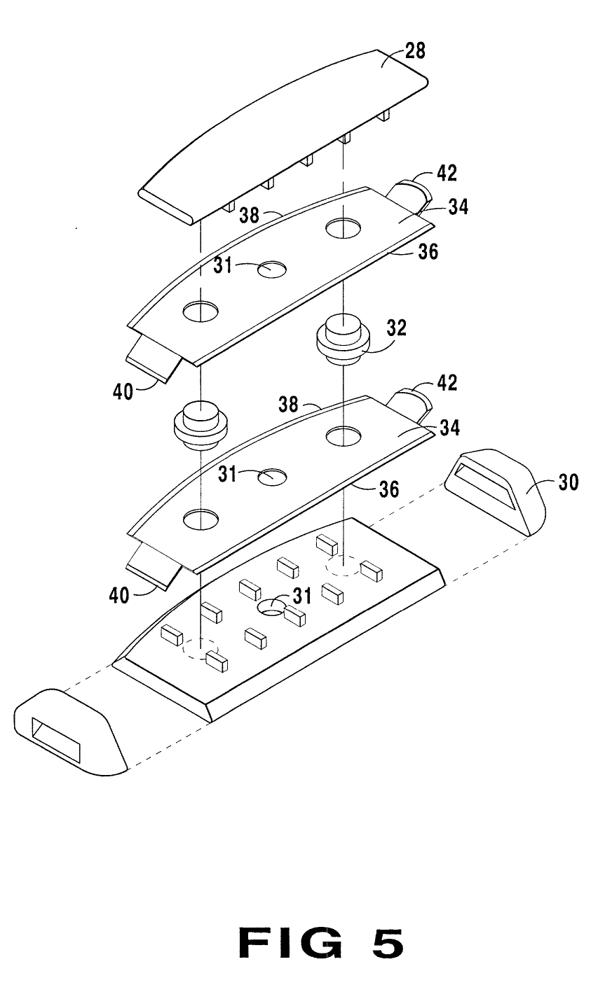

Turning to FIG. 5, therein is shown an exploded view of the components of the shaving head 20 of the preferred embodiment 10. Shown are upper 28 and lower 30 housing members with mating dual central blade spacers 32. Also shown are two blades 34 having a straight edge 36 on one side and a convex edge 38 on the opposing side. Also shown are significantly shorter and smaller straight edge blades 40 on one end and a convex edge blade 42 on the opposing end of the shaving head 20. A conduit 31 is provided for the passage of cleaning water around and through the razor head 20.

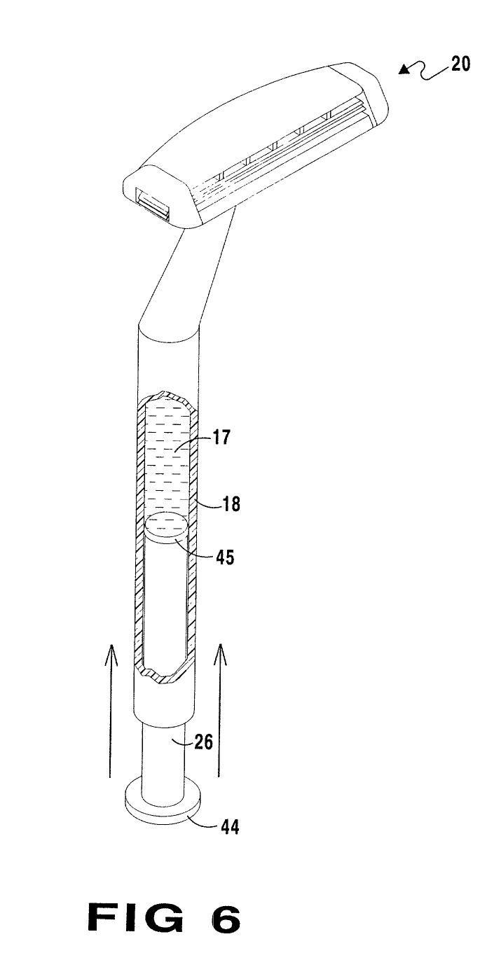

Turning to FIG. 6, therein is shown a sectional view of the hollow handle 18 wherein by use of the plunger 26 an amount of liquid or cream can be stored and collectively dispensed while shaving. Note that the liquid or cream is stored in the conduit 17 of the handle 18. Also shown therein is the head 20 of the razor. Note that the plunger 26 has an enlarged end 44 located so that it will serve as a stop for contacting the end of the handle 18 and also a seal 45.

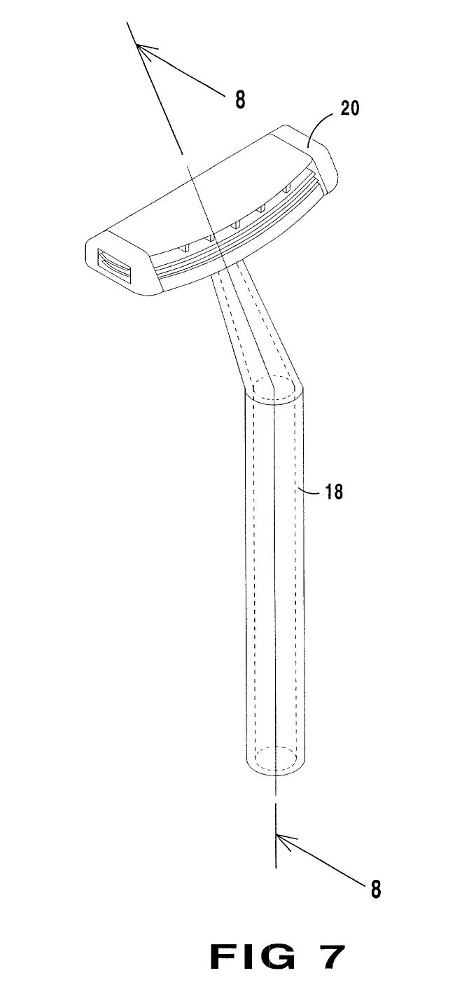

Turning to FIG. 7, therein is shown a perspective view of an additional disposable embodiment of the present invention 10 where the handle 18 and head 20 are made as one piece. Shown therein is a disposable razor 10 with head 20 located at an angular distance from the body or handle of the razor 18. Other features of this embodiment are as previously described.

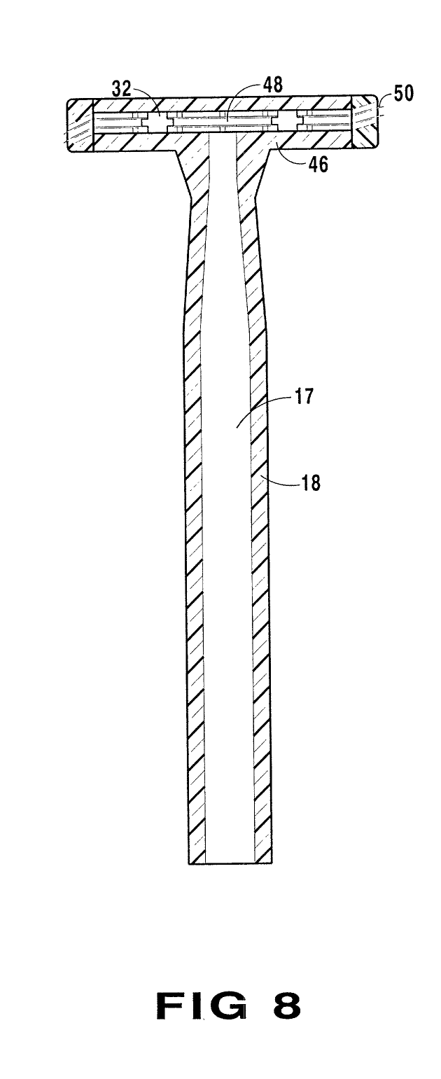

Turning to FIG. 8, therein is shown a cross sectional view of an additional embodiment of the present invention 10 taken from FIG. 7 as indicated. Shown is the handle 18 and the lower blade retaining member 46 and the channel 17 within the handle 18 for cleaning purposes or for carrying oils, creams or liquids to be dispensed through the blade cavity 48. It can be seen that liquid can travel through the conduit 17 and through the blade cavities 48 and out the edge of the blades 50. Also shown are the spacers 32.

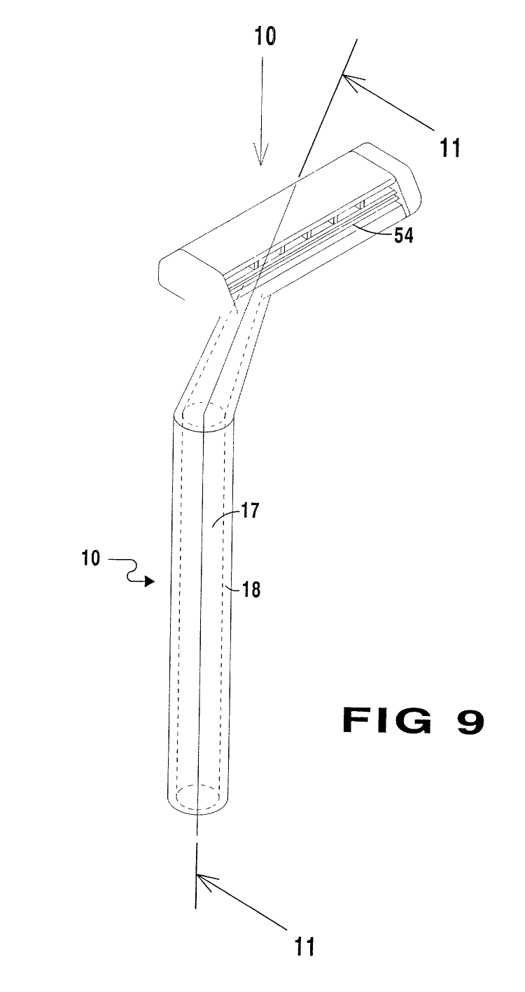

Turning to FIG. 9, therein is shown a perspective view of another embodiment of the present invention 10 having dual blades 54 with only one shaving surface with the channel located down the center of the handle 18 and opening into the blade cavity whereby water can travel from the opening in the end of the handle 18 to the shaving head where it will dislodge shaving debris from around the blades 54 of the safety razor 10. In addition, oils, creams and liquids can be carried within the handle cavity 17 and dispensed while shaving. This embodiment is otherwise the same as previously described.

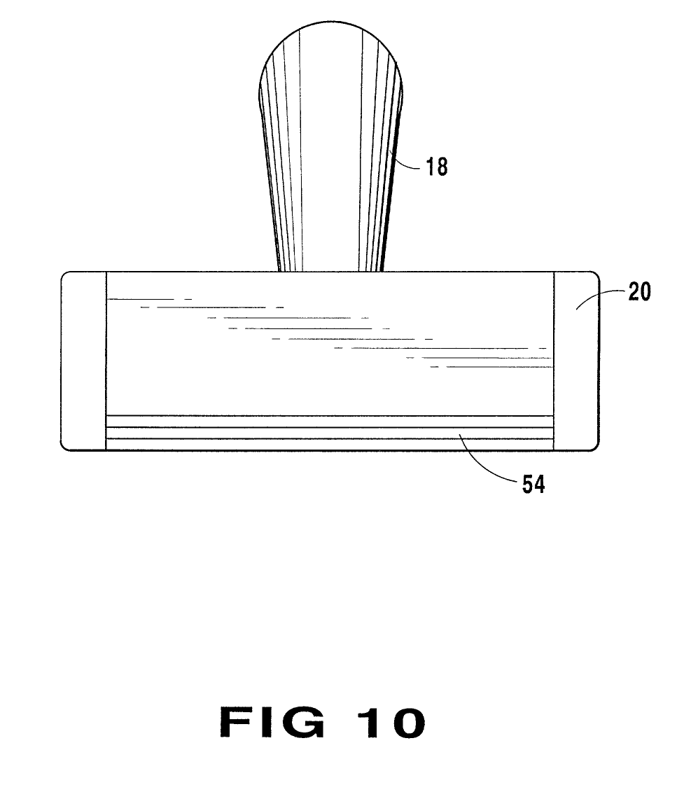

Turning to FIG. 10, therein is shown a top view of the additional embodiment of the present invention 10 taken from FIG. 9 as indicated showing the single, dual-bladed shaving surface 54. Also shown therein is the handle 18 and the head 20.

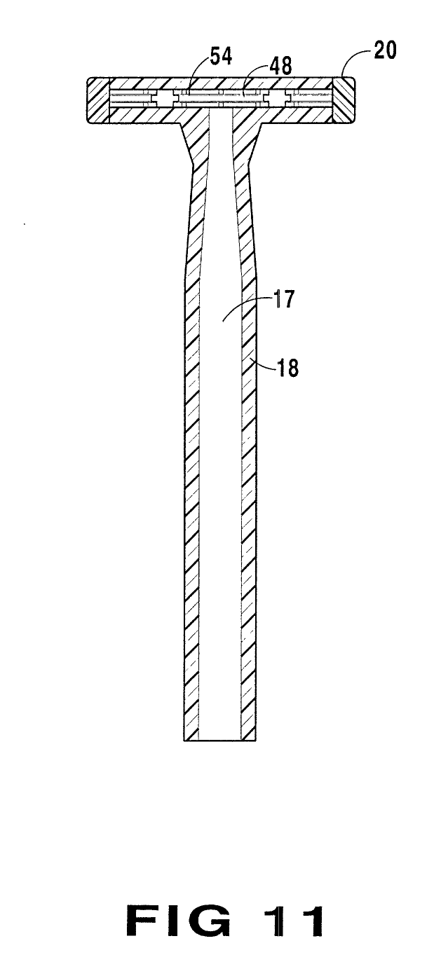

Turning to FIG. 11, therein is shown a cross sectional view of the additional embodiment of the present invention 10 taken from FIG. 9 as indicated, showing the dual blades 54 with one shaving surface with a channel 17 located in the center of the handle 18 and opening into the blade cavity 48 whereby water will travel from the opening in the end of the handle to the shaving head 20 where it will dislodge shaving debris from around the blade 54 surfaces.

What is claimed is new and desired to be protected by Letters Patent is set forth in the claims:

1. An apparatus for shaving, comprising:
a) a head;
b) a handle,
c) said head having blades attached thereto;
d) said handle having a conduit therein;
e) said head having conduits therein; and,
f) said blades having conduits therein whereby fluid can pass through said handle and said head and past said blades so as to clean the apparatus.

2. The apparatus of claim 1, wherein said head further comprises means for being removably attached to said handle.

3. The apparatus of claim 2, wherein said means for attachment further comprises a tongue in groove means.

4. The apparatus of claim 1, wherein said head and handle are made as a single nondetachable unit.

5. The apparatus of claim 1, wherein said head is offset at an angle from said handle.

6. The apparatus of claim 1, wherein said handle has means for a plunger removably attached therein whereby cream can be pushed through said handle.

7. The apparatus of claim 1, wherein said blades further comprise blades with straight edges.

8. The apparatus of claim 1, wherein said blades further comprise blades with convex edges.

9. The apparatus of claim 1, wherein said blades further comprise blades having straight and convex edges.

10. The apparatus of claim 1, wherein said head further comprises blades on its opposite edges.

11. The apparatus of claim 10, wherein said blades further comprise blades with straight edges.

12. The apparatus of claim 10, wherein said blades further comprise blades with convex edges.

13. The apparatus of claim 10, wherein said blades further comprise blades having straight and convex edges.

14. An apparatus for shaving, comprising:
a) a head,
b) a handle;
c) said head having blades attached thereto;
d) said blades having both straight and convex edges;
e) said handle having a conduit therein;
f) said head having conduits therein; and,
g) said blades having conduits therein whereby fluid can pass through said handle and said head and past said blades so as to clean the apparatus.

15. The apparatus of claim 14, wherein said head further comprises blades located along its longer and shorter edges said blades having both straight and convex edges for cutting from the body of the user.
